(19) United States
(12) Patent Application Publication
(10) Pub. No.: US 2007/0090991 A1
(43) Pub. Date: Apr. 26, 2007

(54) Absolute velocity measuring device

(75) Inventors: Tokuji Yoshikawa, Hitachi (JP); Hiroshi Kuroda, Hitachinaka (JP); Satoru Kuragaki, Isehara (JP); Toshiyuki Nagasaku, Kokubunji (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI, LTD., Chiyoda-ku (JP)

(21) Appl. No.: 11/443,195

(22) Filed: May 31, 2006

(30) Foreign Application Priority Data
May 31, 2005 (JP) 2005-158288

(51) Int. Cl. G01S 13/58; G01S 13/60

(52) U.S. Cl. 342/70; 342/196; 342/104; 342/113; 342/114; 342/115; 342/116; 342/117

(57) ABSTRACT

In a configuration of a technique in the related art, since two Doppler sensors are used to measure velocity in two directions, and a set of transmission circuit and reception circuit are provided for each of directions to be measured, a device becomes large and expensive. Moreover, in the related art, since signal processing is performed by using output of each of the two Doppler sensors, axis adjustment in each of emission directions of the two Doppler sensors needs to be performed separately, therefore there is a difficulty that appropriate axis adjustment is complicated and difficult. An absolute velocity measuring device is mounted in a vehicle, and includes a transceiver for transmitting and receiving a wave, a transmission-wave branch section that branches a unidirectional wave transmitted from the transceiver in a plurality of directions, and converges reflected waves of waves branched in the plurality of directions from the ground into the unidirectional wave to be received by the transceiver, and a signal processing section that obtains a signal based on a reflected wave that has been received from the transceiver, and processes the obtained signal and thus calculates a plurality of kinds of behavioral information of the vehicle, and then outputs the relevant behavioral information.

### BACKGROUND OF THE INVENTION

1. Field of the Invention

The present invention relates to an absolute velocity measuring device.

2. Description of the Related Art

A technique of measuring a moving direction and magnitude of velocity of a vehicle using two Doppler sensors is known (for example, JP-A-10-20027). In the technique, two Doppler sensors are used to transmit and receive an electromagnetic wave with respect to two different vehicle-travel-surfaces in a horizontal direction. Based on Doppler signals outputted from the two Doppler sensors respectively, velocity in each of radio emission directions is calculated. Velocity components in the two directions are vector-synthesized, thereby the moving direction and the magnitude of velocity of the vehicle are measured. In the technique, polarized waves of transmission waves are in a relationship of being perpendicular to each other in order to reduce effects of crosstalk when electromagnetic waves having the same frequency are transmitted from the two Doppler sensors. Moreover, an oscillator is shared by the two Doppler sensors to reduce size of a device.

### SUMMARY OF THE INVENTION

In the technique in the related art, two Doppler sensors are used to measure velocity in two directions. In a configuration of the technique, since a set of transmission circuit and a reception circuit are provided for each of directions to be measured, there is a difficulty that a device becomes large and expensive. While an oscillator is shared by the two Doppler sensors in the related art, even if only the relevant portion is shared, contribution to reduction in size and cost of the device is not sufficient.

Moreover, in the related art, since signal processing is performed by using output of each of the two Doppler sensors, a measuring error becomes large unless output of the sensors is synchronized with each other, and axis adjustment in each of emission directions of the two Doppler sensors needs to be performed separately, therefore there is a difficulty that appropriate axis adjustment is complicated and difficult.

In a configuration, a unidirectional wave transmitted from a transceiver is branched in a plurality of directions, and reflected waves from the ground with respect to the branched waves in a plurality of directions are converged into the relevant unidirectional wave and received, and then a plurality of kinds of behavioral information of a vehicle are calculated based on reflected waves that have been received.

### ADVANTAGE OF THE INVENTION

According to embodiments of the invention, a plurality of kinds of information among velocity in a back and forth direction, velocity in a left and right direction, magnitude of velocity, a moving direction, a pitch angle, and a roll angle of a vehicle can be obtained by a set of transmission and reception functions, and consequently an absolute velocity measuring device can be reduced in size and cost compared with a case of using a plurality of transceivers. Therefore, a restriction on a place where the device is installed to a car body is relaxed. Alternatively, since axis adjustment operation can be performed only for a set of transceivers, the axis adjustment operation can be easily performed. Alternatively, since Doppler signals in a plurality of directions are acquired at the same time, behavior of the vehicle can be accurately measured.

### BRIEF DESCRIPTION OF THE DRAWINGS

FIG. 1 is a block diagram of an absolute velocity measuring device of an embodiment of the invention;

FIGS. 2A to 2C are views showing an example of behavioral information of a vehicle as a measuring object of the absolute velocity measuring device 1 of FIG. 1;

FIGS. 3A to 3B are block diagrams of transmitting and receiving sections 101 in FIG. 1;

FIGS. 4A to 4B are views showing structures of a transmission-wave branch section 103;

FIG. 5 is a cross section view of the absolute velocity measuring device 1 in the case of using a structure of FIG. 4A;

FIG. 6 is a view showing a relationship between an emission angle and reception signal intensity simply using the transmitting and receiving section 101 in FIG. 1;

FIGS. 7A to 7C are views showing an example of a relationship between an emission angle and reception signal intensity in a case of using the transmission-wave branch section 103 in FIG. 1;

FIGS. 8A to 8C are views showing an aspect of installing the absolute velocity measuring device 1 of FIG. 1 to a vehicle 900;

FIG. 9 is a flowchart of processing of a signal processing section 104;

FIG. 10 is a view showing a frequency spectrum in the case that an emission pattern is a pattern of FIG. 7C;

FIG. 11 is a view showing a range where moving average is carried out in S103 of FIG. 9;

FIGS. 12A to 12B are views showing results of performing moving average to frequency spectrum of FIG. 10;

FIGS. 13A to 13C are views showing another example of an emission pattern of a transmission wave transmitted from the transmitting and receiving section 101 in FIG. 1;

FIGS. 14A to 14B are views showing an example of installing the absolute velocity measuring device 1 in FIG. 13 to a vehicle;

FIG. 15 is a flowchart of processing of a signal processing section 104 in the example of FIG. 13;

FIGS. 16A to 16B are views showing a frequency spectrum in the example of FIG. 13;

FIG. 17 is a view showing another example of the absolute velocity measuring device 1;

FIGS. 18A to 18B are block diagrams of transmitting and receiving sections 101 in FIG. 17; and

FIG. 19 is a view showing an example of a transmission-direction switcher 1802 in FIG. 18.

### DESCRIPTION OF THE PREFERRED EMBODIMENTS

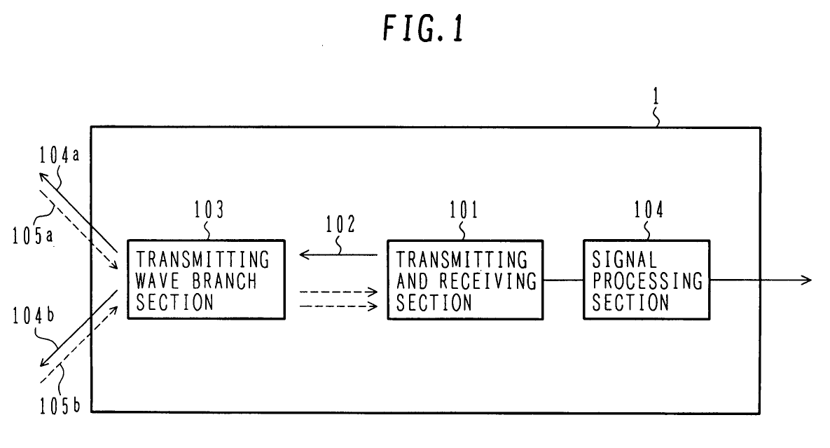

FIG. 1 is a block diagram of an absolute velocity measuring device of an embodiment of the invention. While the device is called absolute velocity measuring device here, it may be called absolute vehicle velocity sensor, ground vehicle velocity sensor, ground velocity sensor, vehicle behavior detection device, or the like.

The absolute velocity measuring device 1 in FIG. 1 includes a transmitting and receiving section 101, transmission wave branch section 103, and signal processing section 104. The transmitting and receiving section 101 transmits a unidirectional wave (light, an electromagnetic wave, sound and the like, which have properties as awave) (102), and a transmitted wave is branched in a plurality of directions (in the figure, an example of two directions is shown) by the transmission wave branch section 103, and then transmitted to a road surface (104a, 104b). Transmitted waves are reflected on the ground, and reflected waves 105a, 105b that have been reflected are received by the transmitting and receiving section 101 via the transmission wave branch section 103.

The transmitting and receiving section 101 generates Doppler signals containing Doppler shift information based on the reflected waves 105a, 105b that have been received, and then outputs the Doppler signals to the signal processing section 104. The signal processing section 104 obtains a plurality of kinds of behavioral information of a vehicle based on inputted Doppler signals, and then outputs the behavioral information.

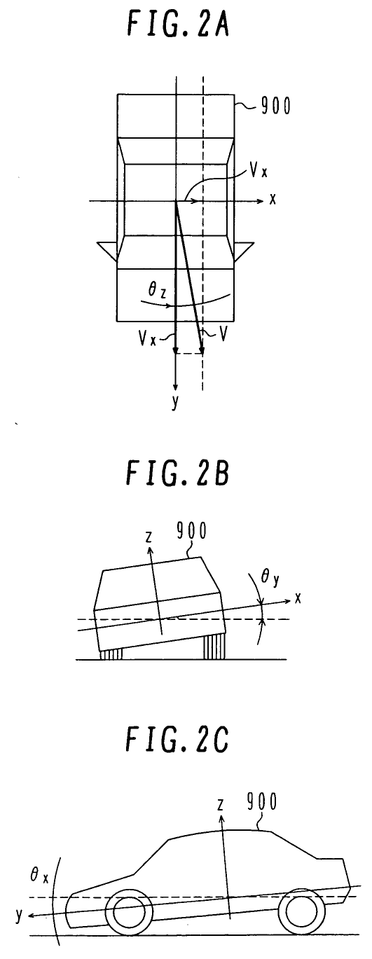

FIGS. 2A to 2C show an example of the behavioral information of the vehicle as a measuring object of the absolute velocity measuring device 1 of FIG. 1. As shown in the figures, an orthogonal coordinate system with a point in the vehicle as the origin is supposed, and an axis in a back and forth direction of the vehicle is defined as y, an axis in a left and right direction of the vehicle is defined as x, and an axis of an up and down direction of the vehicle is defined as z.

In FIG. 2A, which is a view of the vehicle seen from an upper side, velocity of a component y in the back and forth direction of the vehicle parallel to the ground is assumed as velocity Vy in the back and forth direction of the vehicle. Velocity of a component x in the left and right direction of the vehicle parallel to the ground is assumed as velocity Vx in the left and right direction. Magnitude of velocity obtained by vector-synthesizing the velocity Vy in the back and forth direction and the velocity Vx in the left and right direction is assumed as V. An angle formed by the velocity Vy in the back and forth direction and the magnitude of velocity V is defined as a moving direction θz. In FIG. 2B, which is a view of the vehicle seen from the front, an angle formed by the axis x in the left and right direction of the vehicle and the ground is defined as a roll angle θy. In FIG. 2C, which is a view of the vehicle seen from the left side, an angle formed by the axis y in the back and forth direction of the vehicle and the ground is defined as a pitch angle θx.

The absolute velocity measuring device 1 in FIG. 1 obtains a plurality of kinds of behavioral information of the vehicle among such defined, velocity Vy in the back and forth direction, velocity Vx in the left and right direction, magnitude of velocity V, moving direction θz, pitch angle θx, and roll angle θy, and outputs it to other control devices (including a device of controlling behavior of the vehicle based on the relevant information, or a device of notifying the relevant information to a driver, such as an ACC (Adaptive Cruise Control) device, an engine control device, a transmission control device, an ABS (Anti-lock Brake System) device, and a VDC (Vehicle Dynamics Control) device).

The absolute velocity measuring device 1 in FIG. 1 branches a transmission signal from the transmitting and receiving section 101 in a plurality of directions by the transmission-wave branch section 103, and converges reflected signals on the transmission-wave branch section 103 as the relevant transmission signals that are reflected on the ground and then returned. Therefore, a plurality of kinds of vehicle behavior information can be measured by one transceiver, and consequently an advantage of reduction in size, cost, and number of components of the device is obtained.

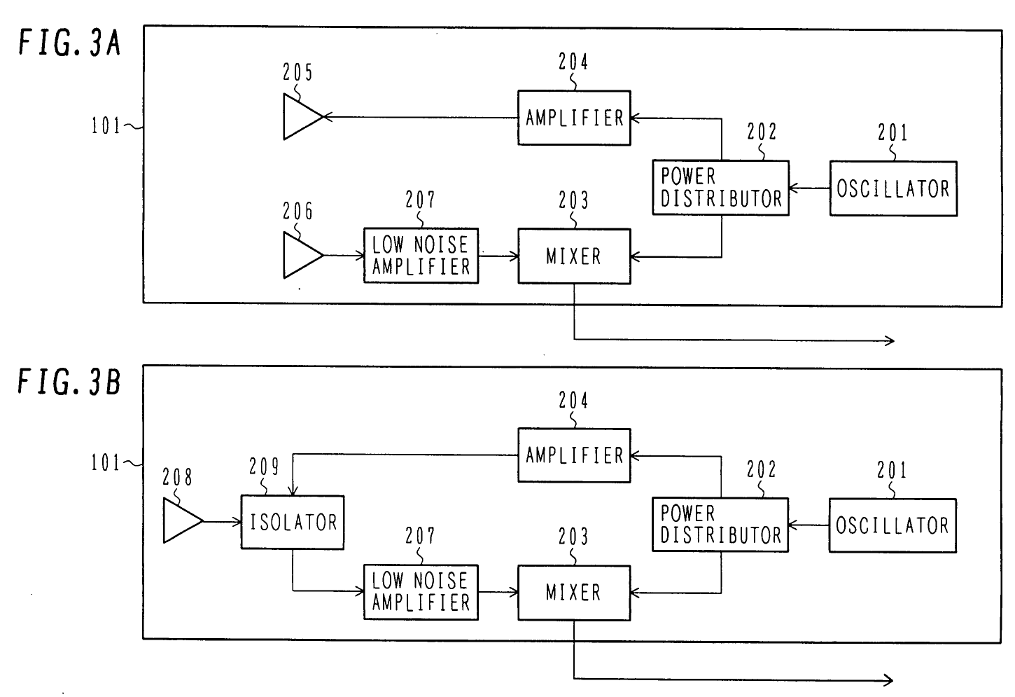

FIGS. 3A to 3B are block diagrams of the transmitting and receiving section 101 in FIG. 1. Here, an electromagnetic wave is used as an example of a wave to be transmitted and received.

FIG. 3A shows an example that a transmission antenna 205 and a reception antenna 206 are independently provided. A high-frequency signal generated in an oscillator 201 is distributed by a power distributor 202, and one of distributed signals is used as a transmission signal, and the other is inputted into a mixer 203. The transmission signal is amplified by an amplifier 204, and then transmitted from the transmission antenna 205. The transmitted transmission signal is reflected on a road surface, and then received by the reception antenna 206. Such a reception signal is inputted into the mixer 203 via a low noise amplifier 207, and a Doppler signal is generated therein. Relative velocity of the vehicle to the road surface is reflected in the Doppler signal, and various kinds of vehicle behavior information including the ground velocity of the vehicle can be acquired based on a frequency spectrum of the relevant signal.

When sufficient transmission power is obtained, the amplifier 204 may be omitted, and when sufficient reception sensitivity is obtained, the low noise amplifier 207 may be omitted.

FIG. 3B shows another example in the case of using a bidirectional antenna 208 that combines functions of the transmission antenna and the reception antenna. The oscillator 201, power distributor 202, mixer 203, amplifier 204, and low noise amplifier 207 are the same as in the example shown in FIG. 3A. In the example, a transmission signal is transmitted from the bidirectional antenna 208 via an isolator 209, and a reflected signal from the ground is separated from the transmission signal using the isolator 209 and extracted as a reception signal, thereby similar measurement as in the case of two antennas shown in FIG. 3A can be realized. Accordingly, a configuration of the antenna can be simplified.

While a common oscillator 201 is used for the transmission signal and the high frequency signal inputted into the mixer 203 in the embodiments shown in FIGS. 3A and 3B, separate oscillators may be used. Moreover, when the transmitting and receiving section 101 in FIG. 3A or FIG. 3B is configured by MMIC (Microwave Monolithic Integrated Circuit) that realizes the section as a 1-chip integrated circuit, cost required for mounting can be reduced.

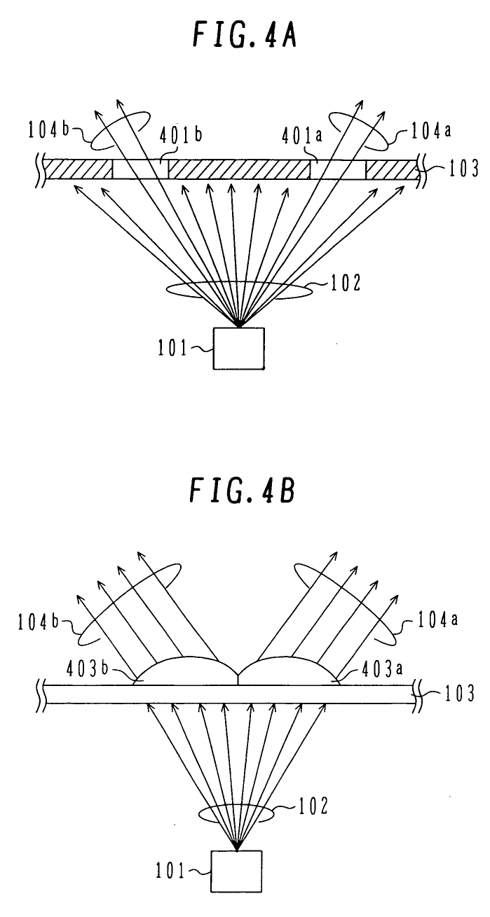

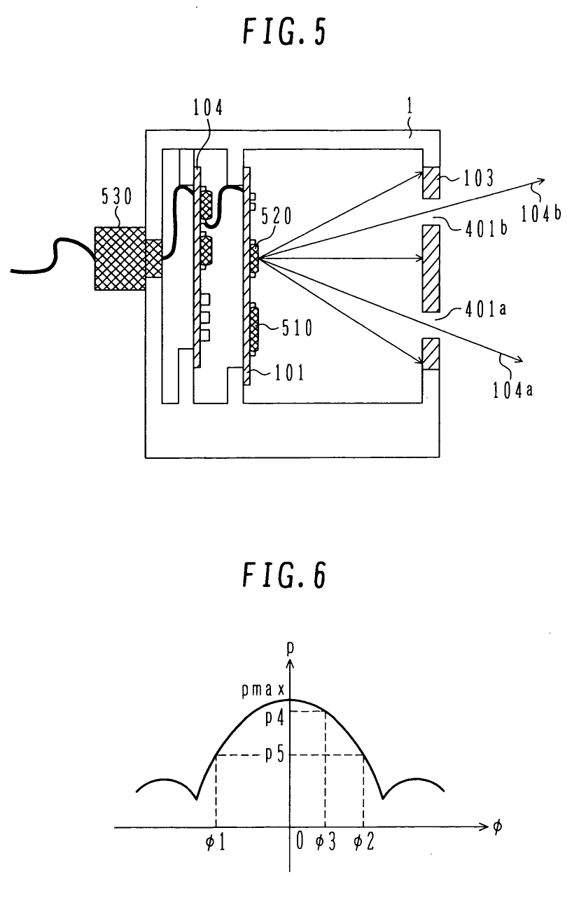

FIGS. 4A and 4B show structures of the transmission-wave branch section 103 in FIG. 1. While two examples are given here, even if either example is used, operation and effects described in and after FIG. 5 are obtained.

FIG. 4A shows an example where the transmission-wave branch section 103 is configured by a region that transmits a wave (a material having a property of transmitting the wave may be used, or a simple space or hole is acceptable. The figure shows a case that the region is configured by holes 401a, 401b), and a region that does not transmit the wave (for example, metal is used). While waves 102 from a radially diverged transmitting and receiving section 101 is shielded by the region that does not transmit the waves in the transmission-wave branch section 103, waves 104a and 104b in directions of the holes 401a, 401b go out to the outside of the transmission-wave branch section 103.

While an example where two holes are provided in the transmission-wave branch section 103 is shown here, at least three holes may be provided, and in this case, the number of waves to be detected is increased, thereby kinds of vehicle behavior information are increased, and consequently an advantage of reduction in size, cost, and number of components of the device is obtained.

FIG. 4B shows an example of using lenses 403a, 403b of a material that transmits waves (for example, resin) as the transmission-wave branch section 103. The lenses 403a, 403b have capability of converging the waves and increasing intensity of the waves. The waves 102 emitted from the transmitting and receiving section 101 are radially diverged, and then injected into the lenses 403a, 403b of the transmission-wave branch section 103. The waves transmitted through the lenses 403a, 403b are changed in travelling directions and furthermore converged by the lenses, and then go out to the outside of the transmission-wave branch section 103.

While an example where the lenses 403a, 403b are provided in the transmission-wave branch section 103 is shown here, at least three lenses may be provided, and in that case, an advantage that strong transmission waves can be transmitted in a plurality of directions, in addition, the number of waves to be detected is increased, thereby kinds of vehicle behavior information are increased, and thereby an advantage of reduction in size, cost, and number of components of the device is obtained. While convex lenses in a transmission direction of the transmission wave are used as the lenses 403a, 403b, the type of lense is not particularly limited, and any lenses are within the scope of embodiments of the invention, as long as they branches the transmission wave in a plurality of directions as shown in the figure. Dimensions can be designed in a way that width of each of the lenses 403a, 403b is 30 mm, a distance between the transmitting and receiving section 101 and the transmission-wave branch section 103 is 40 mm, and a transmission wave angle in the transmitting and receiving section 101 is 60 degrees to 90 degrees. Moreover, the structure is preferably configured in a way that reflected waves from the ground, which have been transmitted through the lenses 403a, 403b, are focused on a reception surface of the transmitting and receiving section 101. The lenses 403a, 403b may by separated or integrated.

FIG. 5 shows a cross section view of the absolute velocity measuring device 1 in a case of using the structure of FIG. 4A.

In FIG. 5, a circuit block necessary for configuring the Doppler sensor includes MMIC 510, and the MMIC 510 is mounted on a high-frequency substrate forming the transmitting and receiving section 101. The transmission antenna for transmitting electromagnetic waves and the reception antenna for receiving reflected signals are formed as an antenna 520 on the high-frequency substrate. Electromagnetic waves emitted from the antenna 520 are emitted to the transmission-wave branch section 103, and only the electromagnetic waves 104a, 104b in the direction of the holes 401a, 401b go out to the outside of the transmission-wave branch section 103. The electromagnetic waves 104a, 104b are reflected on the ground, and similarly transmitted through the holes 401a, 401b and then received by the transmitting and receiving section 101. The transmitting and receiving section 101 generates the Doppler signal containing the Doppler shift information based on reflected waves that have been received, and then outputs it to the signal processing section 104. The signal processing section 104 obtains a plurality of kinds of vehicle behavior information based on an inputted Doppler signal, and then outputs it to another device via a connector 530. When lenses are provided as the transmission-wave branch section 103 here, the structure shown in FIG. 4B is used as the transmission-wave branch section 103.

While the signal processing section 104 and the transmitting and receiving section 101 are shown on different substrates here, they may provided on the same substrate, and in that case, a function of the signal processing section 104 may be incorporated in the MMIC 510.

FIG. 6 shows a relationship between an emission angle and reception signal intensity simply in the transmitting and receiving section 101 in FIG. 1.

Assuming that an angle at which intensity of a signal from the transmitting and receiving section 101 shows a maximum value pmax is a reference angle o, and a horizontal axis shows an angle φ from the reference angle o, and a vertical axis shows reception signal intensity p. The reception signal intensity p is approximately symmetric with respect to the reference angle o as shown in the figure. Here, angles of the transmission waves 104a, 104b from the transmission-wave branch section 103 as shown in FIGS. 4A to 4B are set to be angles φ1, φ2 which are symmetric with respect to the reference angle o, thereby reception signal intensity of the transmission waves becomes equal to each other. Alternatively, the angles of the transmission waves 104a, 104b may be in a combination of angles φ1 and φ3 shown in the figure so that intensity of respective reception signals is different from each other. Alternatively, one of the angles of the transmission waves 104a, 104b may be the angle o, or the angles of the transmission waves 104a, 104b may be set to be the angles φ2 and φ3 in the same angle region with respect to the reference angle o.

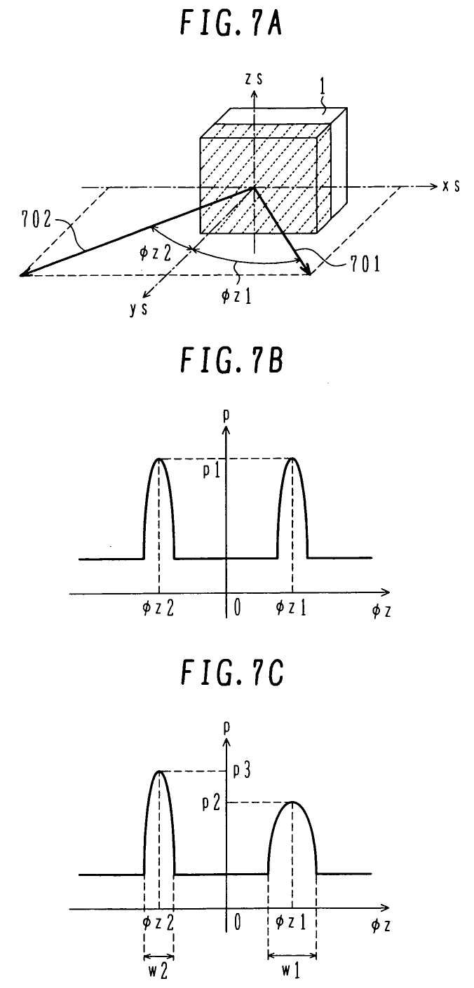

FIGS. 7A to 7C show an example of a relationship between an emission angle and reception signal intensity in a case of using the transmission-wave branch section 103 in FIG. 1.

In the example, the holes 401a, 401b of the transmission-wave branch section 103 are provided parallel to an axis xs in a left and right direction shown in the figure and symmetrically to an axis ys perpendicular to an antenna surface of the antenna 520 (FIG. 5). Thus, the section can be configured in a way that on an xs-ys plane defined by the axis xs in the left and right direction and the axis ys perpendicular to the antenna surface of the antenna 520 (FIG. 5), the transmission waves are emitted in a plurality of directions of arrows 701 and 702 making predetermined angles φz1 and φz2 to the axis ys. When the axis ys is assumed to be the reference angle o, as shown in FIG. 7B, reception signal intensity at the angles φzl and φz2 becomes large compared with reception signal intensity at other angles, and the reception signal intensity at the angles φz1 and φz2 is equally p1.

FIG. 7C shows a relationship between an emission angle and reception signal intensity in the case that the angles φ1 and φ3 shown in FIG. 6 are used as the angles φz1 and φz2. While the reception signal intensity at the angles φz1 and φz2 becomes large compared with the reception signal intensity at other angles similarly to an emission pattern of FIG. 7B, the reception signal intensity is different between the angles φz1 and φz2. Moreover, size or diameters of the holes 401a, 401b are made different from each other (in the cases of lenses 403a, 403b, size or thickness of the lenses are made different from each other), thereby an effective reception wave range w1 at the angle φz1 can be made large compared with an effective reception wave range w2 at the angle φz2.

According to such a configuration, even if information indicating vehicle behavior (for example, relative velocity) detected in respective directions is close or approximate to one another, difference in pattern between a spectrum at the angle φz1 and a spectrum at the angle φz2 is noticed and thus each information can be selected.

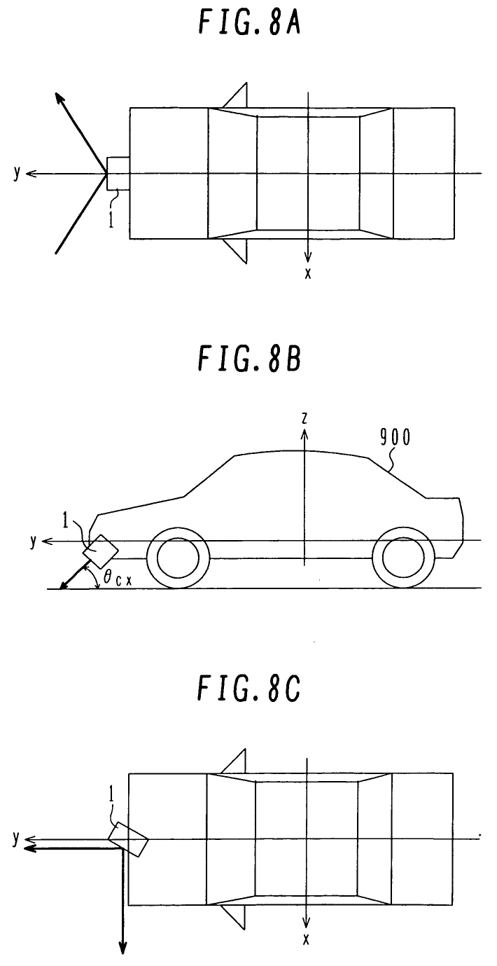

FIGS. 8A to 8C show an aspect of installing the absolute velocity measuring device 1 of FIG. 1 to a vehicle 900.

FIG. 8A is a view of the vehicle seen from an upper side, and FIG. 8B is a view of the vehicle seen from a left side. Here, the absolute velocity measuring device 1 is installed in a way that an antenna surface is directed to a forward direction of the vehicle, or directed to either the front or the rear. The device may be installed in the front or the rear of the vehicle. In the figure, it is installed in a lower side of the front of the vehicle. The device is installed in the front of wheels in this way, thereby influence of mud, dust, or water droplets splashed by front wheels is reduced, and consequently deterioration in measuring accuracy due to a stain can be prevented. That is, in measuring ground velocity using the Doppler signal through transmission and reception of electromagnetic waves or sound waves, when the transmitting and receiving section is covered by the mud, dust or water droplets, intensity of the transmission signal and the reception signal is decreased and thus measuring accuracy is reduced, therefore the device is installed at the front of the vehicle where the device is scarcely influenced by them.

While not shown, the absolute velocity measuring device 1 may be installed at a back side of the front wheels or rear wheels of the vehicle 900. In this case, while a measure for the stain or damage is necessary, since the electromagnetic wave and the like are transmitted to a road surface after wheels have passed thereon, intensity of the reception signal can be secured even if a reflection condition of the road surface is bad due to rainy weather or snow.

The absolute velocity measuring device 1 is installed in a manner that a transmission center direction of the device is parallel to a component y in the back and forth direction of the vehicle, and an angle formed by the transmission center direction and the ground is an angle θcx.

Here, when the angle θcx is made close to 0° (zero degrees) or parallel to the road surface, Doppler frequency obtained from the transmission signal and the reception signal is increased. Therefore, processing capability required for the signal processing section is increased, and consequently the signal processing section becomes expensive. In particular, when θcx=0° (zero degrees), since a signal reflected on the road surface can not be received, the ground velocity can not be measured. On the other hand, when the angle θcx is made close to 90° (perpendicular to the road surface), since frequency of the Doppler signal obtained from the transmission signal and the reception signal is decreased, processing capability required for the signal processing section is decreased. However, when θcx=90°, a component (component in a y-axis direction) corresponding to relative velocity between the vehicle 900 and the road surface is not detected. Thus, the angle θcx is set in consideration of influence on the transmission signal and the reception signal and the processing capability required for the signal processing section. For a typical car, about 45° is preferable.

While the absolute velocity measuring device 1 is installed in a manner that emission directions branched in two are diverged to both sides of the forward direction of the vehicle in the example, such an installation way can be changed depending on physical quantity to be measured and importance of the physical quantity to be measured. That is, when measurement of velocity in the forward direction of the vehicle (y-axis direction) is a main purpose, and measurement of velocity in the left and right direction (x-axis direction) is a secondary purpose, one of the transmission waves branched in two is directed to the forward direction of the vehicle (y-axis direction), thereby measurement accuracy in the direction can be relatively improved.

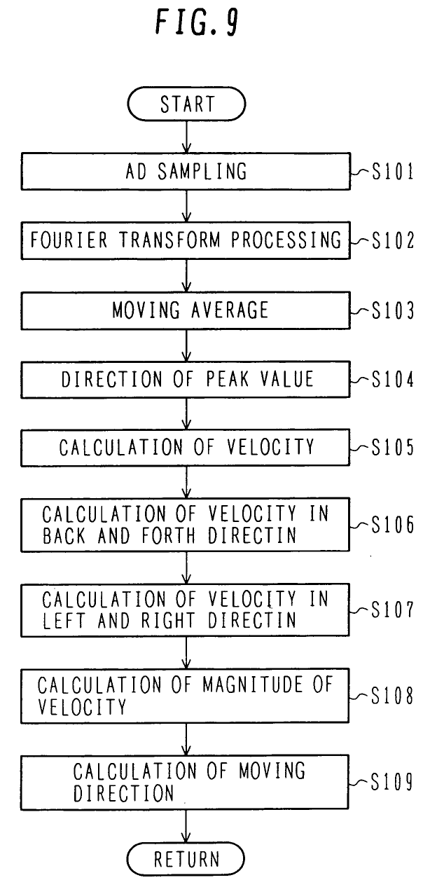

FIG. 9 shows a flowchart of processing of the signal processing section 104.

First, in a step S101, a Doppler signal from the transmitting and receiving section 101 is sampled. Then, processing is advanced to a step S102, wherein a sampled Doppler signal is subjected to Fast Fourier Transform processing to obtain a frequency spectrum.

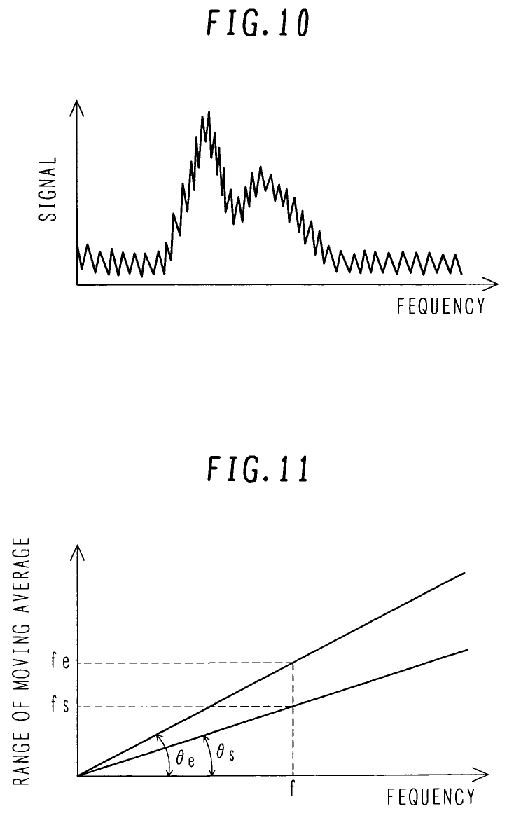

FIG. 10 shows a frequency spectrum in the case of an emission pattern of FIG. 7C.

Next, in a step S103, a processing result in S102 is subjected to moving average with a frequency axis.

FIG. 11 shows a range where the moving average is carried out in the step S103 of FIG. 9.

As shown in FIG. 11, frequency fs at which the moving average is started and frequency fe at which it is ended are set to be increased with increase in frequency, and difference between the ending frequency fe and the starting frequency fs is set to be increased with further increase in frequency.

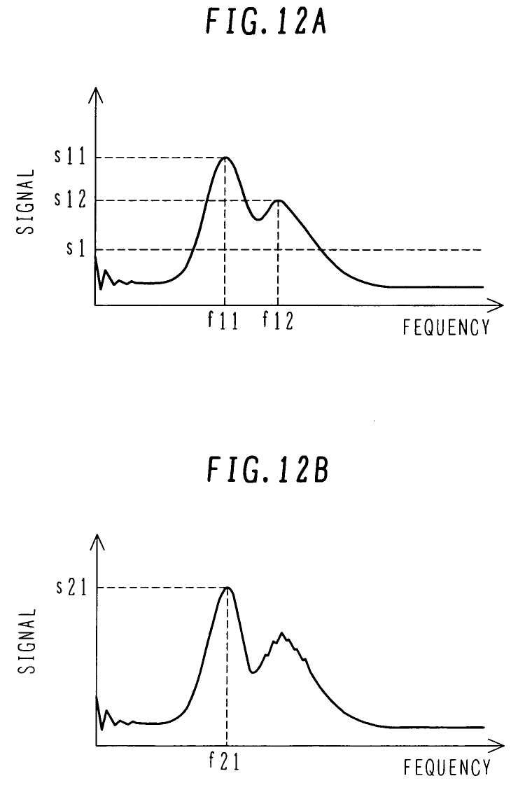

FIGS. 12A to 12B show results of performing moving average to the frequency spectrum of FIG. 10.

FIG. 12A shows result of performing moving average to the frequency spectrum of FIG. 10. Then, the processing is advanced to a step S104, wherein frequency f11 and frequency f12 of signals having a largest value s11 and a second-largest value s12 in portions where signals are larger than a predetermined value sl and in a convex pattern (peak value) are detected respectively. When only one signal having the peak value larger than the predetermined value sl exists, frequency of the one signal that was detected is assumed as the frequency f11 and the frequency fl2. Then, the frequency f11 is assumed as frequency in the transmission direction φz2, and the frequency fl2 is assumed as frequency in the transmission direction φzl. Then, the processing is advanced to a step S105, wherein velocity vr in the transmission direction φz1 is calculated by equation 1 based on the frequency fl2 in the transmission direction φz1, and velocity vl in the transmission direction φz2 is calculated by equation 2 based on the frequency f11 in the transmission direction φz2.
Vr=(c·f12)/(2·fc) (equation 1)
Vl=(c·f11)/(2·fc) (equation 2)
c: the velocity of light
fc: transmission frequency

Then, the processing is advanced to a step S106, wherein velocity Vy in the back and forth direction is calculated by equation 3 based on the velocity vr in the transmission direction φz1 and the velocity vl in the transmission direction φz2.
Vy=(vr·COS(ARCTAN(TAN φz1/COS θcx))+vl·COS(ARCTAN(TAN φz2/COS θcx)))/COS θcx (equation 3)

Then, the processing is advanced to a step S107, wherein velocity Vx in the left and right direction is calculated by equation 4 based on the velocity vr in the transmission direction φz1 and the velocity vl in the transmission direction φz2.
Vx=(vr·SIN(ARCTAN(TAN φz1/COS θcx))+vl·SIN (ARCTAN(TAN φz2/COS θcx)))/COS θcx (equation 4)

Then, the processing is advanced to a step S108, wherein magnitude of velocity V is calculated by equation 5 based on the velocity Vy in the back and forth direction and the velocity Vx in the left and right direction.
V=√(Vy·Vy+Vx·Vx) (equation 5)

Then, the processing is advanced to a step S109, wherein moving direction θz is calculated by equation 6 based on the velocity Vy in the back and forth direction and the velocity Vx in the left and right direction.
θz=ARCTAN(Vx/Vy) (equation 6)

When the range where the moving average is carried out is set in the step S103, slopes θs, θe of the frequencies fs, fe in a map of FIG. 11 may be set based on divergence ranges w1, w2 of the transmission wave in an emission pattern. In this case, preferably, when the divergence range is large, the slope is set such that difference between the frequency fe and the frequency fs is increased, and when the divergence range is small, the slope is set such that difference between the frequency fe and the frequency fs is decreased.

The moving average is carried out at inclinations of the divergence range w1 and the divergence range w2, and when the moving average is carried out at the inclination of the divergence range w1, FIG. 12A is given for the frequency spectrum of FIG. 10, and when the moving average is carried out at the inclination of the divergence range w2, FIG. 12B is given for the frequency spectrum of FIG. 10. Then, in next S104, a frequency fil of the signal having the largest value s11 is detected as a result of the moving average at the inclination of the divergence range w2, in which the divergence range of the transmission wave is narrow (FIG. 12B). The frequency f11 is set to be the frequency in the transmission direction φz2. Then, when the second-largest signal s12 is larger than the predetermined value s1 as a result of the moving average at the inclination of the divergence range w1 (FIG. 12A), the frequency f12 of the signal s12 is set to be the frequency in the transmission direction φz1. When the frequency in the transmission direction φz1 has not been able to be set, the frequency in the transmission direction φz1 is made equal to the frequency in the transmission direction φz2.

In this way, the absolute velocity measuring device 1 of FIG. 1 branches the transmission signal from one transmitting and receiving section 101 in a plurality of directions by the transmission-wave branch section 103, and converges reflected signals on the transmission-wave branch section 103 as the relevant transmission signals that were reflected on the ground and then returned, and then receives the signals by the transmitting and receiving section 101. A peak value of a frequency spectrum of a received signal is obtained, thereby a plurality of kinds of vehicle behavior information such as the velocity Vy in the back and forth direction, velocity Vx in the left and right direction, magnitude of velocity V, and moving direction θz of the vehicle can be obtained.

Next, an example of measuring the velocity Vy in the back and forth direction and the pitch angle θx by the absolute velocity measuring device 1 is described.

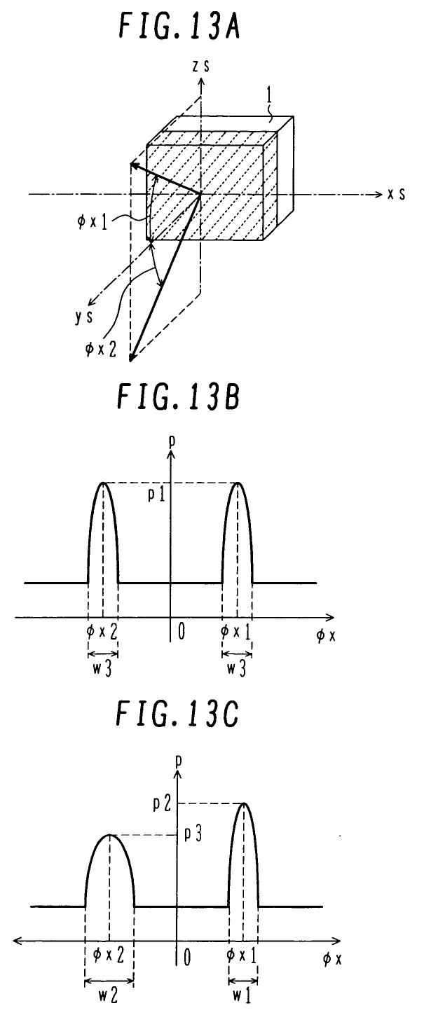

FIGS. 13A to 13C show another example of an emission pattern of a transmission wave transmitted from the transmitting and receiving section 101 in FIG. 1.

As shown in FIG. 13A, the transmission wave is emitted in directions φx1, φx2 about the axis xs in the left and right direction of the absolute velocity measuring device 1 from the axis ys perpendicular to a transmission surface of the absolute velocity measuring device 1. That is, on a plane defined by the axis zs in the up and down direction of the antenna surface and the vertical axis ys perpendicular to the antenna surface, a wave transmitted from the transceiver is branched in a plurality of directions making predetermined angles vertically to the vertical axis ys respectively. Here, a central direction (in the example, the axis ys) of the directions φx1 and φx2 is assumed to be a transmission center direction. FIG. 13B shows an example of an emission pattern of the transmission wave. A direction φx about the axis xs in the left and right direction is given in a horizontal axis, and intensity p of the transmission wave is given in the vertical axis. Intensity of transmission waves in the directions φx1 and φx2 is made strong compared with that in other directions. Moreover, the transmission waves are made to have the same intensity p1 in the directions φx1 and φx2. FIG. 13C shows an example of an emission pattern of the transmission wave, which is different from that of FIG. 13B. While intensity of the transmission waves in the directions φx1 and φx2 is made strong compared with intensity in other directions similarly to the emission pattern of FIG. 13B, intensity of the transmission wave in the direction φx1 is made different from that in the direction φx2. The divergence range w1 of the transmission wave in the direction φx1 is also made different from the divergence range w2 in the direction φx2.

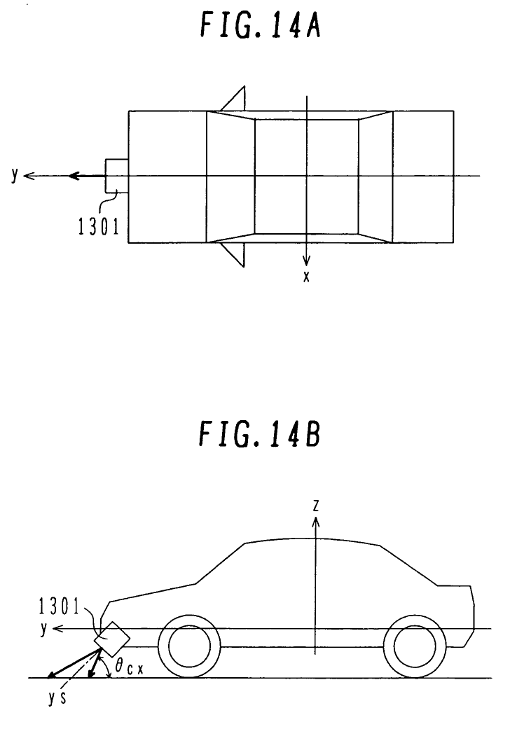

FIGS. 14A and 14B show an example of installing the absolute velocity measuring device 1 in FIG. 13 to a vehicle.

FIG. 14A is a view of the vehicle seen from an upper side, and FIG. 14B is a view of the vehicle seen from a left side. The absolute velocity measuring device 1 is installed in a way that the antenna surface is directed to a travelling direction of the vehicle, or directed to either the front or the rear. In the figure, the device is installed in a lower side of the front of the vehicle. The reason for this, which is the same as described in FIGS. 8A to 8C, is to reduce influence of dust, mud and water droplets splashed by wheels. The transmission center direction of the absolute velocity measuring device 1 is also designed similarly to that in FIGS. 8A to 8C such that it is parallel to the component y in the back and forth direction of the vehicle, and the angle formed by the transmission center direction and the ground is an angle θcx. The angle θcx is set in consideration of influence on the transmission signal and the reception signal and the processing capability required for the signal processing section within a range of a value that is more than 0° (zero degrees) and lower than 90°, as described in FIGS. 8A to 8C.

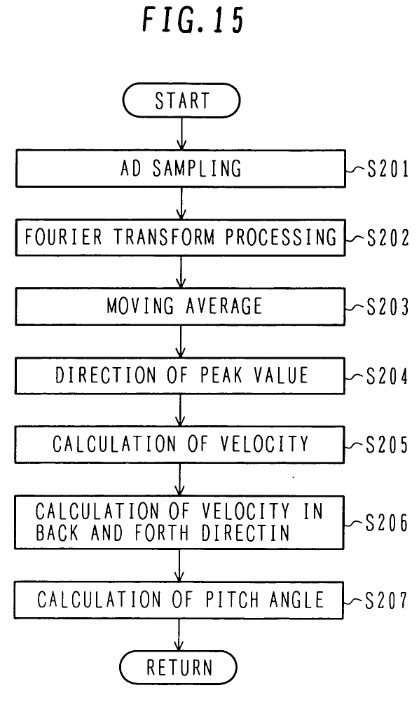

FIG. 15 is a flowchart of processing of the signal processing section 104.

First, in a step S201, a Doppler signal from the transmitting and receiving section 101 is sampled. Then, processing is advanced to a step S202, wherein a sampled Doppler signal is subjected to Fast Fourier Transform processing to obtain a frequency spectrum.

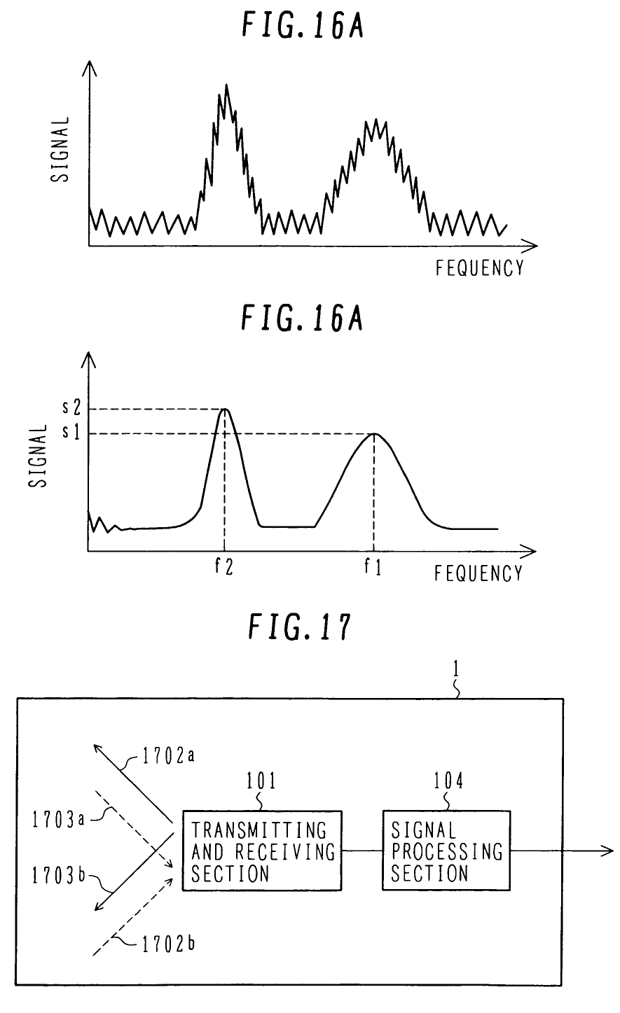

FIG. 16 shows a frequency spectrum.

In a case of the emission pattern of FIG. 13B, a frequency spectrum as shown in FIG. 16A is obtained. Then, in S203, a processing result in S202 is subjected to moving average with a frequency axis. A range where the moving average is carried out is set in the same way as the case that the range where the moving average is carried out is set in the step S103 of FIG. 9. When the moving average is carried out, FIG. 16B is given for the frequency spectrum of FIG. 16A.

Then, the processing is advanced to a step S204, wherein a largest value s2 and a second-largest value s1 in portions where a signal pattern is convex are detected, and the larger frequency between them is set to be frequency fl in the transmission direction φx1. Then, the smaller frequency between them is set to be frequency f2 in the transmission direction φx2.

Then, the processing is advanced to a step S205, wherein velocity vf in the transmission direction φx1 is calculated by equation 7 based on the frequency f1 in the transmission direction φx1, and velocity vb in the transmission direction φx2 is calculated by equation 8 based on the frequency f2 in the transmission direction φx2.
Vf=(c·f1)/(2·fc) (equation 7)
Vb=(c·f2)/(2·fc) (equation 8)
c: the velocity of light
fc: transmission frequency

Then, the processing is advanced to a step S206, wherein velocity Vy in the back and forth direction is calculated by equation 9 based on the velocity vf in the transmission direction φx1 and the velocity vb in the transmission direction φx2.
Vy=√(Vf·Vf+Vb·Vb−2·Vf·Vb·COS(φx1+φx2))/SIN(φx1+φx2) (equation 9)

Then, the processing is advanced to a step S207, wherein the pitch angle θx is calculated by equation 10.
θx=ARCCOS(Vx/Vy)−θcx−φx1 (equation 10)

In the same principle, when the absolute velocity measuring device 1 is installed to a vehicle with the transmission center direction of the device being perpendicular to the ground, the velocity Vx in the left and right direction and the roll angle θy can be measured.

In the same principle, transmission waves in three directions may be transmitted to the road surface to measure the pitch angle θx and velocity Vy in the back and forth direction, velocity Vx in the left and right direction, magnitude of velocity V, and moving direction θz. Alternatively, the roll angle θy and velocity Vy in the back and forth direction, velocity Vx in the left and right direction, magnitude of velocity V, and moving direction θz may be measured.

Moreover, transmission waves in four directions may be transmitted from one transmitting and receiving section 101 to measure the pitch angle θx and roll angle θy, velocity Vy in the back and forth direction, velocity Vx in the left and right direction, magnitude of velocity V, and moving direction θz.

Alternatively, two transmitting and receiving sections 101 are used, and transmission waves in two directions are transmitted from the respective transmitting and receiving sections 101 to measure the pitch angle θx and roll angle θy, velocity Vy in the back and forth direction, velocity Vx in the left and right direction, magnitude of velocity V, and moving direction θz.

FIG. 17 shows another example of the absolute velocity measuring device 1.

The absolute velocity measuring device 1 includes the transmitting and receiving section 101 and the signal processing section 104. The transmitting and receiving section 101 transmits waves in at least two directions toward the ground (1702a, 1702b), and receives reflected waves 1703a, 1703b of transmitted waves from the ground. As the waves, electromagnetic waves or sound waves are used. When the device receives the reflected waves 1703a, 1703b, it outputs Doppler signals based on the reflected waves 1703a, 1703b. The signal processing section 104 calculates any two or more of the velocity Vy in the back and forth direction or velocity Vx in the left and right direction, magnitude of velocity V, moving direction θz, pitch angle θx and roll angle θy of the vehicle based on Doppler signals outputted by the transmitting and receiving section 101, and then outputs them.

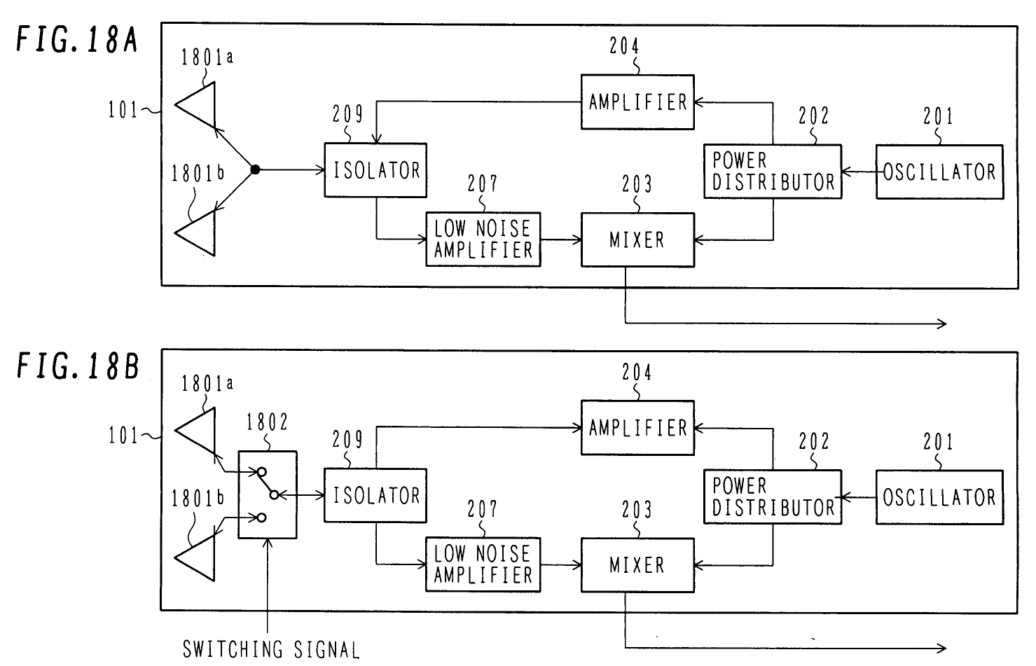

FIGS. 18A and 18B show block diagrams of transmitting and receiving sections 101 when electromagnetic waves are used as the waves.

FIG. 18A shows a configuration similar to that of FIG. 3B, but different in that bidirectional antennas 1801a and 1801b are provided. In the example, transmission waves are transmitted from the bidirectional antennas 1801a and 1801b in different directions from each other at the same time. The same processing as in the signal processing section 104 in FIG. 2 is performed in the signal processing section 104 based on Doppler signals of reflected waves.

FIG. 18B also shows a configuration similar to that of FIG. 3B, but different in that a transmission direction switcher is provided between the two bidirectional antennas 1801a, 1801b, and the isolator 209. In the example, the bidirectional antennas 1801a and 1801b are directed in different directions from each other, and a transmission and reception antenna for transmitting a transmission signal is switched in a time-shared manner for transmission.

To switch a direction of the transmission wave, a switching signal from the signal processing section 104 is received by a transmission direction switcher 1802, and the transmission wave is transmitted from a bidirectional antenna selected according to the switching signal. Then, based on a Doppler signal of a reflected signal and the switching signal, each of Doppler signals of reflected signals 1703a, 1703b is subjected to Fourier Transform processing in the signal processing section 104 to obtain a frequency spectrum. Each frequency spectrum is subjected to moving average processing to perform peak detection in a transmission direction. Subsequent processing is the same as in the signal processing section 104 in FIG. 1.

While the bidirectional antennas 1801a and 1801b are used in the example of FIGS. 18A and 18B, the transmission antenna and the reception antenna may be separately provided as in FIG. 3A.

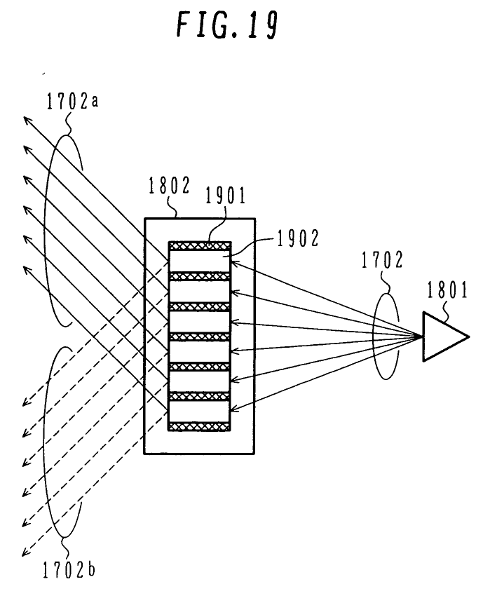

FIG. 19 shows an example of the transmission-direction switcher 1802.

The transmission-direction switcher 1802 is in a configuration where electrode layers 1901 and liquid crystal layers 1902 are alternately stacked. Waves transmitted from the bidirectional antennas 1801 are transmitted through the liquid crystal layers 1902 of the transmission-direction switcher 1802 and go out to the outside of the absolute velocity measuring device. When voltage of the electrode layers 1901 is changed, molecular orientation of the liquid crystal layers 1902 is changed, and consequently directions of the transmission waves transmitted through the liquid crystal layers 1902 are changed. The voltage of the electrode layers 1901 is controlled in order to switch directions of transmission waves 1702a, 1702b in a time-shared manner, and furthermore focus the transmission waves 1702a, 1702b like the lenses 403a and 403b.

What is claimed is:

1. An absolute velocity measuring device comprising:
a transceiver for transmitting and receiving a wave, and being mounted in a vehicle;
a transmission-wave branch section for branching a unidirectional wave transmitted from said transceiver in a plurality of directions, and converging reflected waves from the ground for the waves branched in the plurality of directions into the unidirectional wave to be received by said transceiver; and
a signal processing section for obtaining a signal based on the reflected wave which is received from said transceiver, and processing an obtained signal and calculating a plurality of kinds of behavioral information of the vehicle, and then outputting the relevant behavioral information.

2. The absolute velocity measuring device according to claim 1,
wherein said transceiver outputs a Doppler signal containing Doppler shift information based on the reflected wave which is received to said signal processing section.

3. The absolute velocity measuring device according to claim 2,
wherein said signal processing section calculates velocity in each of transmission direction components of a wave based on a result of performing Fourier Transform to the Doppler signal.

4. The absolute velocity measuring device according to claim 3,
wherein said signal processing section sets each of the transmission direction components based on the result of Fourier Transform to velocity of the relevant transmission direction component with intensity or a divergence range of a signal.

5. The absolute velocity measuring device according to claim 3,
wherein said signal processing section carries out moving average of the result of performing the Fourier Transform with a frequency axis, and calculates velocity of the transmission direction component based on a result of the moving average.

6. The absolute velocity measuring device according to claim 1,
wherein the plurality of kinds of behavioral information include velocity in a back and forth direction, velocity in a left and right direction, magnitude of velocity, a moving direction, a pitch angle, and a roll angle of the vehicle.

7. The absolute velocity measuring device according to claim 1,
wherein said transceiver has a transmission-wave switching function for switching a wave in a plurality of directions in a time-shared manner.

8. The absolute velocity measuring device according to claim 1,
wherein, in said transmission-wave branch section, at least one of intensity and a divergence range of the wave is varied depending on a branch direction of the wave.

9. The absolute velocity measuring device according to claim 1,
wherein said transmission-wave branch section includes a region that transmits the wave and a region that does not transmit the wave.

10. The absolute velocity measuring device according to claim 1,
wherein said transmission-wave branch section includes a lens.

11. An absolute velocity measuring device comprising:
a transceiver for transmitting and receiving a wave, and being fixed to a vehicle in a way that an antenna surface is directed to the front of a vehicle;
a transmission-wave branch section for, on a plane defined by an axis in a left and right direction of the antenna surface and a vertical axis perpendicular to the antenna surface, branching a wave transmitted from said transceiver in a plurality of directions making predetermined angles in left and right with respect to the vertical axis respectively, and converging reflected waves from the ground for the branched waves in the plurality of directions into the unidirectional wave to be received by said transceiver; and
a signal processing section for obtaining a Doppler signal containing Doppler shift information based on a reflected wave which is received by said transceiver, and calculating velocity in a back and forth direction, velocity in a left and right direction, magnitude of velocity, and a moving direction of the vehicle from each of transmission direction components obtained based on a result of performing Fourier Transform to the Doppler signal.

12. An absolute velocity measuring device comprising;:
a transceiver for transmitting and receiving a wave, and being fixed to a vehicle in a way that an antenna surface is directed to a travelling direction of a vehicle;
a transmission-wave branch section for, on a plane defined by an axis in an up and down direction of the antenna surface and a vertical axis perpendicular to the antenna surface, branching a wave transmitted from said transceiver in a plurality of directions making predetermined angles vertically with respect to the vertical axis respectively, and converging reflected waves from the ground with respect to the branched waves in the plurality of directions into the unidirectional wave to be received by said transceiver; and
a signal processing section for obtaining a Doppler signal containing Doppler shift information based on a reflected wave which is received from said transceiver, and calculating velocity in a back and forth direction and a pitch angle of the vehicle from each of transmission direction components obtained based on a result of performing Fourier Transform to the Doppler signal.
